(19) United States
(12) Patent Application Publication
(10) Pub. No.: US 2023/0073985 A1
(43) Pub. Date: Mar. 9, 2023

(54) BULK DATA TRANSFER BETWEEN MESH NODES

(71) Applicant: Eaton Intelligent Power Limited, Dublin 4 (IE)

(72) Inventors: Rohit Ramchandra Deshpande, Pune (IN); Sonali Sameer Londhe, Pune (IN); Abhijit Dattatray Gundawar, Pune (IN)

(21) Appl. No.: 17/902,315

(22) Filed: Sep. 2, 2022

(30) Foreign Application Priority Data
Sep. 3, 2021 (IN) 202111039931

(51) Int. Cl. H04W 28/02; H04L 67/563

(52) U.S. Cl. CPC H04W 28/021; H04L 67/563; H04W 84/18

(57) ABSTRACT

A method of data transfer to a plurality of devices on a mesh network includes receiving bulk data at a proxy device in the mesh network; storing, at the proxy device, the bulk data; confirming, to a source of the bulk data, that the bulk data is received; after confirming that the bulk data is received, performing a transfer of the bulk data packet-by-packet to at least one other node in the mesh network; and performing a unicast communication to identify missing packets. The transfer can be or include a cascade transfer in which the data is transferred packet-by-packet to a next available node in the mesh network that itself passes a received packet to its next available node in the mesh network.

### CROSS-REFERENCE TO RELATED APPLICATION

This application claims priority to Indian Provisional Application No. 202111039931, filed Sep. 3, 2021.

### BACKGROUND

Electronic devices such as hazardous area light fixtures can require firmware updates after installation but may be located at difficult to reach or dangerous locations. While it is possible to deliver an over-the-air (OTA) update from a mobile device to a hazardous area light fixture, there may be 100-250 fixtures on a particular premise and a person may need to be in proximity to each fixture to deliver the update, which in addition to being time consuming, can be challenging or dangerous for the person to reach each fixture. Even for cases where a mesh network is implemented for the light fixtures, a person may still need to be in the hazardous area for the time-consuming process so that their mobile device remains in communication with at least one of the light fixtures that acts as a proxy device to communicate with the other light fixtures over the mesh network during the entire update process.

### BRIEF SUMMARY

A bulk data transfer between mesh nodes is described that uses a first node to start an update of other nodes within a mesh network packet-by-packet once the first node is updated.

A method of data transfer includes receiving bulk data at a proxy device in a mesh network; storing, at the proxy device, the bulk data; confirming, to a source of the bulk data, that the bulk data is received; after confirming that the bulk data is received, performing a transfer of the bulk data packet-by-packet to at least one other node in the mesh network; and performing a unicast communication to identify missing packets. In some cases, the transfer is a cascade transfer involving transferring of the bulk data packet-by-packet from the proxy device to a next available node in the mesh network that itself passes a received packet to its next available node in the mesh network. In some cases, the transfer is a group transfer in which the proxy device publishes to a group of subscriber nodes that have subscribed to the proxy device address to transfer the bulk data packet-by-packet.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example operating environment for bulk data transfer.

FIG. 2 illustrates a bulk data transfer method with cascading transfer.

FIGS. 3A and 3B illustrate operations of the described cascading methodology.

FIG. 4 illustrates a process flow for entering OTA mode.

FIG. 5 illustrates a process flow for packet-by-packet transfer of bulk data.

FIG. 6 illustrates an example sanity check sequence.

FIG. 7 illustrates a bulk data transfer method with group transfer.

### DETAILED DESCRIPTION

A bulk data transfer between mesh nodes is described that uses a first node to start an update of other nodes within a mesh network packet-by-packet once the first node is updated.

Through the described techniques, it is possible to transfer bulk data, such as for a firmware upgrade process, from a mobile device to one of the electronic devices in a mesh network and then have the nodes in the mesh network update themselves.

The mesh network can be a Bluetooth® low energy (BLE) mesh, Zigbee mesh, Wi-Fi mesh, and the like.

In order to flash multiple nodes with bulk data such as a new firmware image, packets are transferred from a proxy node to the other nodes in the mesh network on a packet-by-packet basis (from each node to another node in this manner) so that once a node receives all the packets, that device can program (or flash) itself, enabling almost simultaneous updates of all the devices in a given network. This can be referred to as a cascading methodology (or “cascade transfer”). In some cases, the original transfer from the proxy node is to a single node, which then transfers to a next node. In some cases, the original transfer from the proxy node is to a group of subscription nodes that subscribe to the publication of the proxy node.

The bulk data transfer (e.g., firmware image transfer) can occur while the devices on the mesh network are currently operating in normal operation mode. Thus, a user (who provides the bulk data transfer to a proxy node) is not impacted while the bulk data is being transferred from node to node.

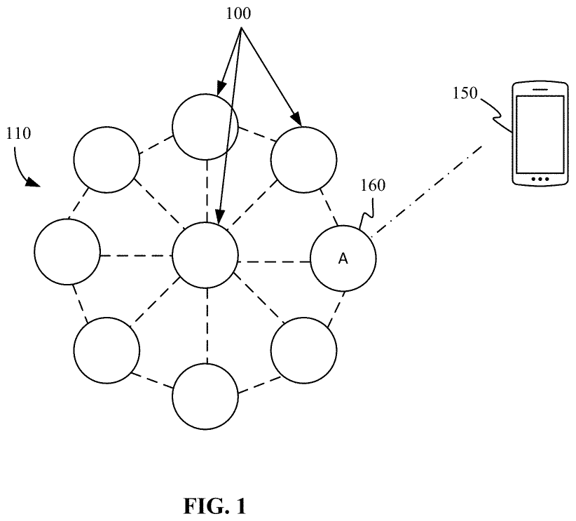

FIG. 1 illustrates an example operating environment for bulk data transfer. Referring to FIG. 1, a plurality of electronic devices 100 can communicate with each other over a mesh network 110. The electronic devices 100 are represented as nodes in the mesh network 110. The mesh network may be a partially connected mesh network or a fully connected mesh network. Nodes in the network 110 can relay messages by flooding (the message is sent through every outgoing link except the one the message was received from) or routing (the message hops from node to node until it reaches its destination). When communicating by a flooding technique, controlled flooding may be used, for example SNCP (Sequence Number Controlled Flooding) and RPF (reverse path forwarding).

For a device that is not part of the mesh network, such as mobile device 150, communication on the mesh network 110 is conducted via a proxy device 160. In this environment, it is expected that each node is capable of receiving a communication of bulk data from the mobile device 150, storing the bulk data locally (e.g., at a “scratch pad” memory), and sending the bulk data to nearby nodes. Thus, each node is capable of receiving an image/bulk data from a nearby node or from the mobile device 150 using the same secure proprietary bulk data transfer protocol for the particular mesh network.

All the nodes in the mesh are capable of transferring bulk data to a nearby node in the same mesh network in order to increase the speed of transfer from an initiating device.

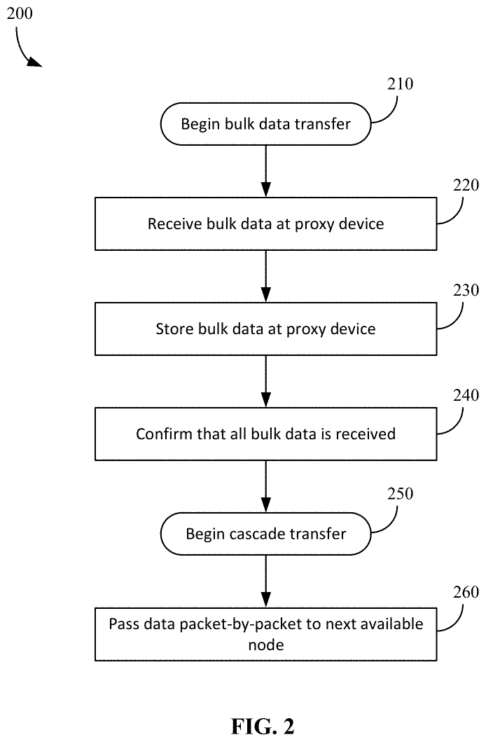

FIG. 2 illustrates a bulk data transfer method with cascading transfer. Referring to FIG. 2, a bulk data transfer method 200 to all nodes in a group can begin (210) with a mobile device, such as mobile device 150 communicating with a proxy device in the mesh network 110. Once the first node, node ‘A’, which is the Proxy device 160, receives (220) the firmware image/bulk data from the mobile device entirely, node A can store (230) the firmware image into its scratch pad memory. The node A verifies that the received firmware image is a valid image/bulk data. Once the proxy device, node A, confirms (240) to the source of the bulk data (the mobile device 150) that it has received the entire image/bulk data, node A will begin (250) the cascade transfer by passing (260) the image/bulk data packet by packet to the next unicast address (e.g., its own address+1). As part of the cascade transfer, the next address, node “A+1” will pass the image/bulk data to the next device (i.e., “A+2”), as and when the packets are received to it. All the devices store these packets into their individual scratch pad memories in the packet sequence (e.g., if a packet is dropped or lost, the scratch pad would have a gap in the scratch pad memory for the missing packet at its expected sequence location). Thus, using this process, the mesh nodes will cascade the image/bulk data amongst the various other nodes within the same mesh network, enabling a very fast upgrade of firmware for all the mesh nodes. This process can be utilized for various other bulk data transfer that initiates via a mobile device or a remote gateway for all the nodes within the mesh.

Advantageously, because the proxy device receives the entire bulk data package and directs the cascading technique, the mobile device can disconnect and the user of the mobile device is not required to be at a hazardous premise for longer than updating a single device.

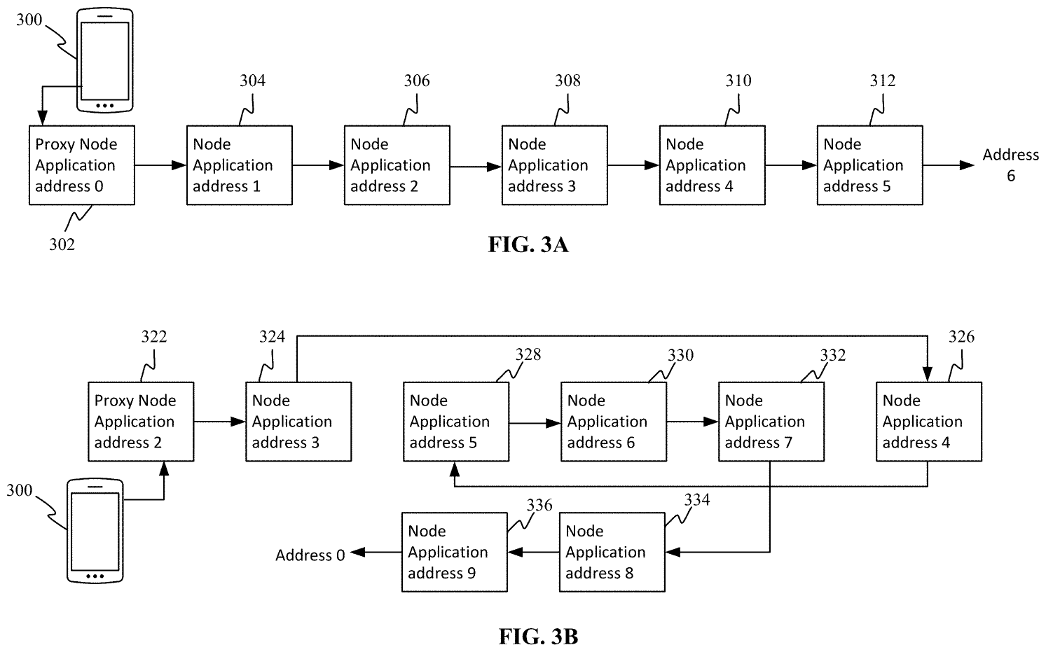

FIGS. 3A and 3B illustrate operations of the described cascading methodology. As described with respect to FIGS. 1 and 2, a mobile device can communicate with one of the nodes in the mesh network, which acts as a proxy into the mesh network. Referring to FIG. 3A, a mobile device 300 may communicate with the node 302 at address 0 so that node 302 becomes the proxy node for the mobile device 300. The proxy node 302 at address 0 sends the data to the node 304 at address 1, which sends the data to the node 306 at address 2, which sends the data to the node 308 at address 3, which sends the data to the node 310 at address 4, which sends the data to the node 312 at address 5, which sends the data to the node at address 6, and so on.

Of course, the mobile device 300 is not required to use the node at address 0 as the proxy node; nor are the electronic devices required to be located in a manner such that the nearest adjacent node has the next address.

For example, referring to FIG. 3B, the mobile device 300 may communicate with the node 322 at address 2 so that node 322 becomes the proxy node for the mobile device. The proxy node 322 at address 2 sends the data to the node 324 at address 3, which sends the data to the node 326 at address 4, which sends the data to the node 328 at address 5, which sends the data to the node 330 at address 6, which sends the data to the node 332 at address 7, which sends the data to the node 334 at address 8, which sends the data to the node 336 at address 9. Since this example is for a set of 10 nodes, the node 336 at address 9 then returns to the first node in the address list and sends the data to the node at address 0, which would send the data to the node at address 1, which would send the data to the node 322 at address 2. Since the node 322 at address 2 would already have the data, the cascading transmission of data can stop. As can be seen in the figure, the node 328 at address 5 is actually the closest node to the node 324 at address 3, but the node 324 at address 3 sends the data to the node 326 at address 4 instead of the node most proximate in physical location. This assists in ensuring that each node is updated.

In a specific implementation of a firmware update for a plurality of electronic devices on a mesh network, the data transfer can begin with entering over-the-air (OTA) update commands for the devices to all enter the OTA mode.

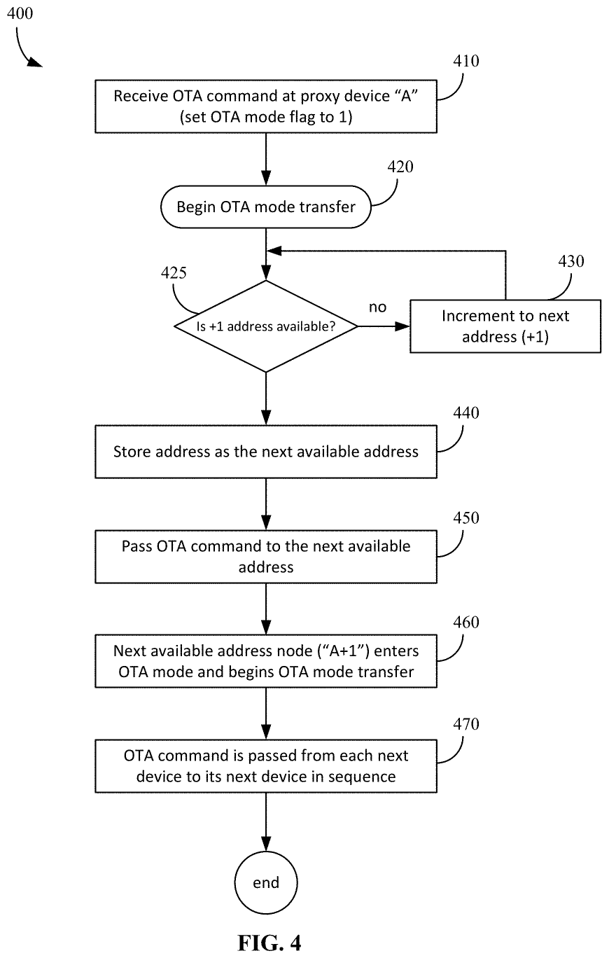

FIG. 4 illustrates a process flow for entering OTA mode. Referring to FIG. 4, a process 400 for directing devices to enter OTA mode can begin after a proxy node receives (410) a command for OTA transfer. Upon receipt of the OTA command, the device can set the OTA mode flag to 1 (or other indicator for that device to initiate the bulk transfer and update process). In some cases, process 400 can be performed while process 200 such as described with respect to FIG. 2 is performed so that OTA mode propagation can occur while the proxy node starts collecting all the packets from the mobile device, confirms that all packets were received successfully, and verifies to the mobile device that the control is passing on to the application and the mobile device can disconnect. In some cases, process 400 begins after the proxy node has received the bulk data transfer from the mobile device as part of beginning the cascade transfer (operation 250 of FIG. 2) such that the OTA mode propagation can be conducted after the mobile device disconnects. The Proxy node will pass the data to the next node (own unicast address+1) if it is available, else it will search for next node and will pass the command to the next node. Thus, all the devices in the mesh network will enter into the OTA mode and transfer the packets. Since unicast communication is used in between the nodes, it is possible to reliably set all the nodes in a group to enter OTA mode.

Accordingly, the OTA mode propagation can begin 420 and the proxy device “A” pings the next address location (“A+1”) to determine (425) if the node at the next address is available. If the node at the next address is not available (e.g., does not return receipt), proxy device “A” increments (430) to the next node address (e.g., “A+1” +1). Once an available node is determined, the proxy device “A” stores (440) the address as the next available address and passes (450) the OTA command to the node at that next available address. The node at that next available address enters (460) OTA mode upon receipt of the OTA command and begins the OTA mode transfer process such as described in operations 420, 425, 430, 440, and 450. In this manner, the OTA command is passed (470) from each next device to its next device in sequence. It can be noted that a node that is connected and active on the mesh may not want the firmware upgrade (e.g., the device may already be updated); such a node can respond accordingly so that the message will be passed on to the next node.

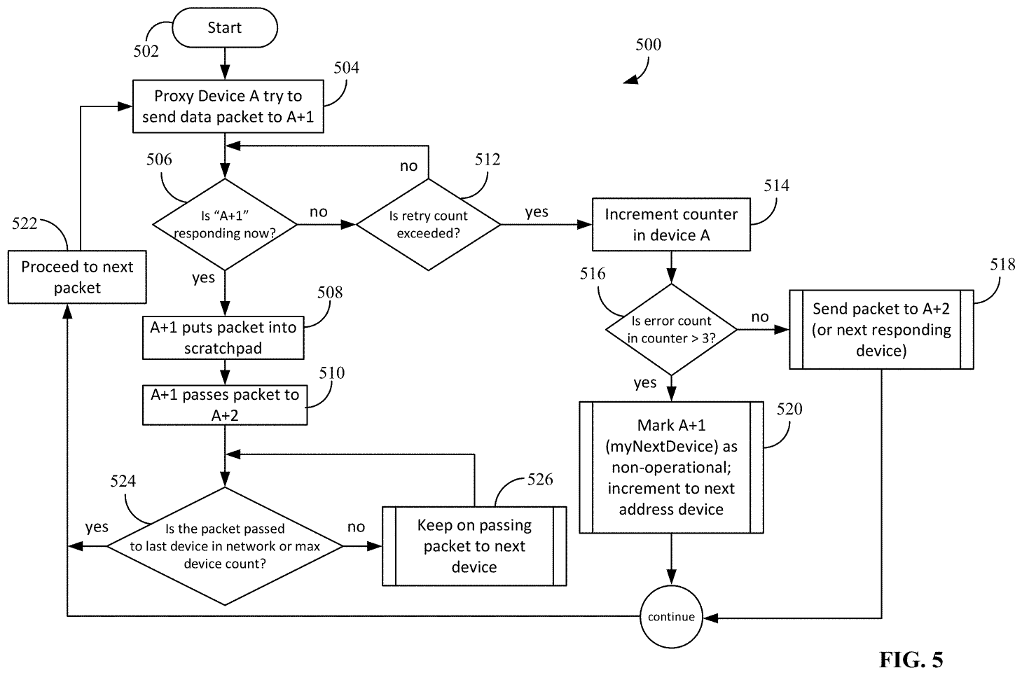

FIG. 5 illustrates a process flow for packet-by-packet transfer of bulk data. Referring to FIG. 5, a method 500 of data packet transfer of packet 1 to packet N can be used to realize operation 250 of FIG. 2 in a manner that addresses scenarios where devices may become unresponsive momentarily or permanently (e.g., because of a device problem that takes it offline). In this example, method 500 can begin 502 with the Proxy device A sending (504) a data packet to the next device (A+1). Proxy device A sends each data packet (from packet 1 to packet N) sequentially to the next device. Here, A refers to the unicast address of the proxy device and A+1 is the second node unicast address. Upon receipt of a data packet, A+1 responds to device A to indicate receipt, which allows proxy device A to determine (506) whether A+1 is responding, stores (508) the data packet in its scratchpad memory, and passes (510) the data packet to its next device (A+2).

If during the determination step 506, proxy device A does not receive an indication that its next device received the packet in a designated timeframe, proxy device A can determine (512) whether a retry count is exceeded and retry sending the same data packet. If the retry count is determined in operation 512 to exceed the threshold, proxy device A increments (514) its error counter, which is used to determine (516) whether an unresponsive next device should be marked non-operational. While the error counter is less than a specified number, the packet is sent to the next device in the sequence (e.g., A+2). If A+2 does not respond, A+3 is tried and so on. Whichever device responds is saved as PossibleNextDevice; the PossibleNextDevice will store the packet in to its scratchpad.

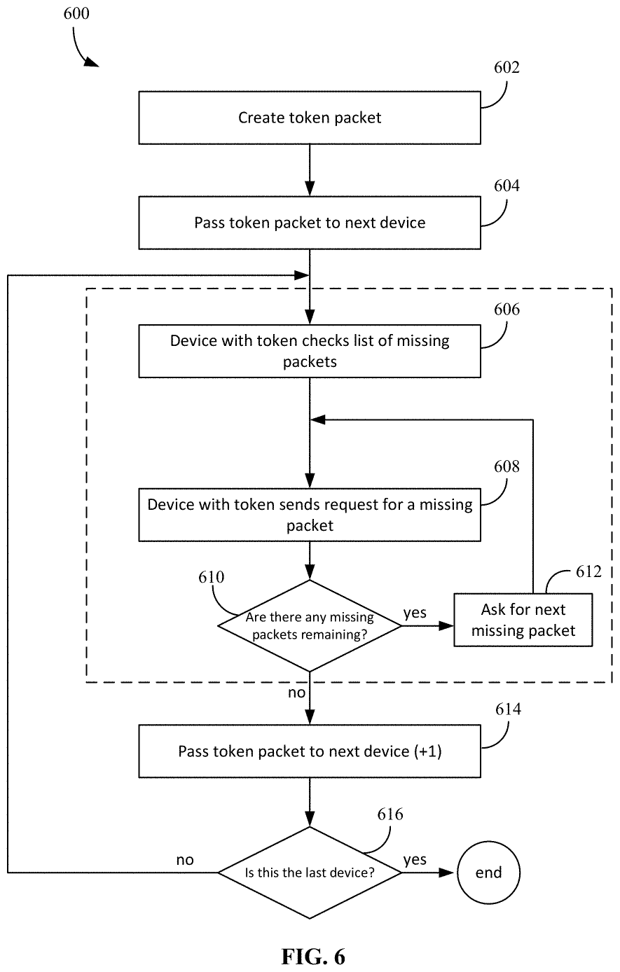

As illustrated, in case a device's currently indicated next device is unresponsive, the device sending the packet (e.g., initially the proxy A device) tries to find the next device in the sequence to send the packet to (518). A maximum number of retry attempts of a device is attempted (“retry count”), after which the packet will be passed to the next available device in sequence. There is a possibility that the previous packet was never passed to that next available device (e.g., A+2) in sequence and there is packet gap in the A+2 device, which can be addressed by the sanity check process described with respect to FIG. 6.

In addition to retrying a particular packet, if it is determined in operation 516 that a certain number of retry attempts occur (i.e., error counter is greater than specified number, such as 3 in this example), then the next device (e.g., A+1) is marked (520) by the proxy device as non-operational and the next device in the sequence is stored as the NextPossibleDevice to which proxy device A sends data packets in operation 504 (e.g., retry counts and error counter are now based on the next device in the sequence). In this example, if the maximum retry fails for 3 consecutive times, then the device will be marked as unresponsive and no further communication will be performed with this device during the OTA bulk data transfer.

During operation 518, the proxy device receives an indication that the next responding device (e.g., A+2) received the packet and that next responding device puts the packet into its scratchpad and passes the packet on to its next device, similar to operations 508 and 510. Indeed, once a packet is sent from the proxy device to a next device, the packet continues to be passed from device to device, and proxy device A proceeds (522) to next packet to send out (which may occur as soon as proxy device A receives an indication that another device received the current packet). A representation of this action is shown in operations 524 and 526, where so long as the packet is not passed to the last device in the network or maximum device count, the packet is passed on to the next device. For example, if proxy device A receives the packet from one of the other devices (e.g., such as described in FIG. 3B), proxy device A can determine (524) that the packet has been passed to the last device in the network/maximum device count.

Once all the packets are transferred, a sanity check sequence can be performed to identify missing packets.

FIG. 6 illustrates an example sanity check sequence. Referring to FIG. 6, the sanity check sequence 600 can be triggered by the Proxy node, for example, once determination 524 described with respect to FIG. 5 indicates that the last packet has been passed to the last device in the network/maximum device count. For the sanity check sequence 600, the proxy node creates (602) a token packet. Once the token is generated and the token packet is created, the proxy node passes (604) the token packet to the next device (e.g., A+1). The device with the token checks (606) its list of missing packets. For example, the device can walk through the packet sequence in its scratchpad and check if any packet is missing. If a particular packet is missing, the device can indicate the missing packet in a list. The device with the token then sends (608) a request for a missing packet. In some cases, the communication with the proxy device indicates the number of missing packets and then the specific sequence numbers of those packets. The Proxy device can then send the specific missing packets for routing to the device requesting the missing packets (e.g., unicast communication). Once all missing packets have been requested (and received), the token packet is passed (614) to the next device. The proxy device can send the token to the next device in the sequence. The processes of 606, 608, 610, 612, and 614 are repeated until it is determined (616) that the token packet was passed in operation 614 to the last device.

In some cases, the token is passed from one device to another and the device having hold of the token will sequentially ask for the missing packets to nearby devices. This can prevent random devices to start asking for missing packets. The response of the device with the token packet will be a unicast. The Proxy device will maintain a timeout for a token. If no response is generated, then the token will be regenerated and sent to next device.

Advantageously, a user does not need to remain at a hazardous premise to update the electronic devices on the mesh network. The mobile device can initiate and completely transfer the image/bulk data to the Proxy node (any of the nodes currently used as proxy). Once all the packets are received by the proxy, the user can leave and the proxy will start transferring one packet after other sequentially. However, because each node that receives a particular packet then sends it out to all of its nearby nodes for routing, it is possible for the network to get flooded with messages.

In certain implementations, the time duration in between the packets is calculated such that the network does not get flooded. There can be multiple techniques used to reduce the flooding:

In one implementation, a time delay is introduced in between the packets sent from the Proxy node to the network. Any added time delay does not impact the user experience as there is no dependency on the mobile device.

In another implementation, the proxy node packets can be passed on to an optimized count of devices at a time (e.g., 20 devices for each set). In this implementation, once the first set of devices receive the data then the next set of devices will be passed the data.

In yet another implementation, flooding can be addressed by optimization of the hop count (also known as time to live for the packet). Each time a packet is sent to another node, the hop count can decrement and once the hop count reaches zero, the packet can be discarded from the network.

In some cases, a combination of these implementations may be used.

Since the data transfer described herein for the cascading techniques is unicast, the data transfer is reliable since the sending node/device is configured to wait for the response. In contrast, when using a broadcast mechanism, all the nodes receive packet simultaneously and hence they do not send an acknowledgement, thus the sending node/device is not aware whether all the nodes (or even which ones) received the packets and it is possible not all the devices would be updated.

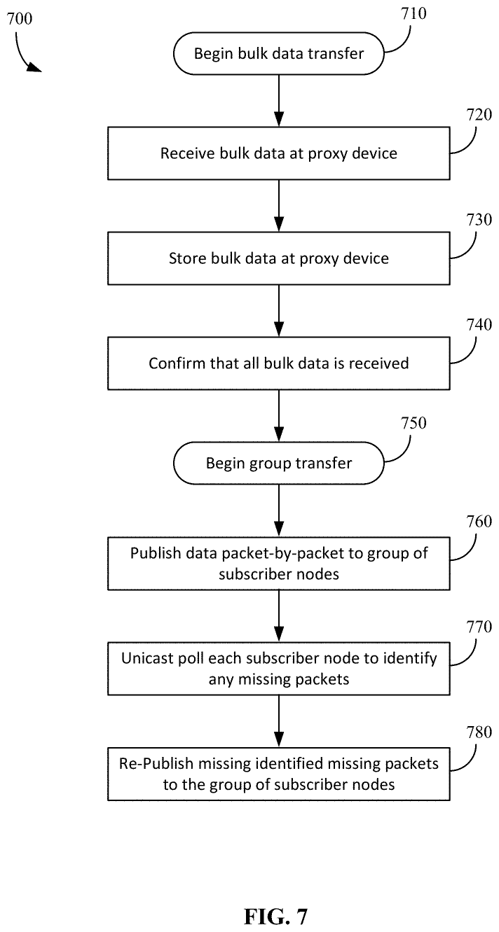

By using a unicast addressed data transfer, a retry mechanism is possible, which reduces errors. However, if a broadcasting data transfer is used, a unicast polling method is incorporated, as described with respect to FIG. 7, which reduces errors otherwise occurring.

FIG. 7 illustrates a bulk data transfer method with group transfer. Referring to FIG. 7, a bulk data transfer method 700 to all nodes in a group can begin (710) with a mobile device, such as mobile device 150 communicating with a proxy device in the mesh network 110. Once the first node, node ‘A’, which is the Proxy device 160, receives (720) the firmware image/bulk data from the mobile device entirely, node A can store (730) the firmware image into its scratch pad memory. The node A verifies that the received firmware image is a valid image/bulk data. Once the proxy device, node A, confirms (740) to the source of the bulk data (the mobile device 150) that it has received the entire image/bulk data, node A will begin (750) the group transfer by publishing (760) the image/bulk data packet by packet to a group of subscriber nodes. Other nodes in the mesh network can receive the packets as each packet transfers around the mesh network. In some cases, the group transfer includes a cascade transfer from each of the subscriber nodes to remaining nodes of the mesh network via a next available node in the mesh network (such as described above with respect to FIGS. 3A and 3B).

The publish/subscribe model for message transport is invoked where a node generates a message and other nodes subscribe to the address of the node that generated the message so that the other nodes receive the message. For a single transaction of a message sent and received, the sender publishes the message to an address (unicast, group or virtual) and the receiver node that is subscribed to this address processes the data. Nodes can publish and subscribe to unicast, group, and virtual addresses.

Once all the packets are transferred, node A performs a unicast poll (770) of each subscriber node to identify any missing packets. Node A then re-publishes (780) the identified missing packets to the group of subscriber nodes. The identified missing packets are transferred to the remaining nodes in the mesh. Any of the remaining nodes missing one of those identified missing packets consumes the packet. That is, a unicast poll of each subscriber node can be performed to identify any missing packets; and upon receiving any identified missing packets from each subscriber node, the identified missing packets can be republished to the group of subscriber nodes.

As an example implementation of a method of bulk data transfer with group transfer, a first device publishes each packet of the bulk data with a time delay of T between each broadcast/publication. The time delay T is based on the time required for the message to travel through the entire mesh. That is, a first device publishes or broadcasts a first packet of the bulk data to a group of devices (who have subscribed to this publish address). Then, after the time delay T, the first device sends the next packet.

Once all the packets are sent by the first device, the first device polls each of the individual devices to confirm whether or not each individual device has received all the packets. The first device can perform the polling using a unicast polling mechanism (one after other). If any of the devices missed a packet, that device responds to the poll request with the list of missing packets. There can be a limit on a maximum number of retry that the first device will do before marking a particular device as faulty. The first device then resends the packets indicated by that device indicating a missing packet to all the devices as a publish message. Thus, if any other device in the mesh is also missing the packet resent by the first device, that other device will re-receive the packet and consume the packet. This can further reduce the time to update the other devices as it is possible that missing packets will be resolved at a device before that device is polled. In similar fashion, the first device will poll remaining devices and publish the missing packets until all the devices receive all the packets.

The speed of bulk data transfer can be increased through the group transfer method, since multiple devices receive the packets at same time. Moreover, advantageously, through the methodology of identifying the missing packets from one device and sharing the missing packets to all devices (not just the one indicating that the packet is missing), it is possible to further increase speed of update.

Since the messaging (transfer of packets from the first device to the other devices/nodes) is broadcast based, the method of transfer will be fast. In addition, since the polling is unicast based, the method is able to incorporate the advantage of having a communication reliability as-well. Thus, the group transfer method can be considered both fast and reliable.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A method of bulk data transfer, comprising:
receiving bulk data at a proxy device in a mesh network;
storing, at the proxy device, the bulk data;
confirming, to a source of the bulk data, that the bulk data is received;
after confirming that the bulk data is received, performing a transfer of the bulk data packet-by-packet to at least one other node in the mesh network; and
performing a unicast communication to identify missing packets.

2. The method of claim 1, wherein performing the transfer of the bulk data packet-by-packet to at least one other node in the mesh network comprises performing a cascade transfer of the bulk data packet-by-packet to a next available node in the mesh network that itself passes a received packet to its next available node in the mesh network.

3. The method of claim 2, wherein performing the unicast communication to identify missing packets comprises, after performing the cascade transfer of the bulk data, providing to each node in the mesh network any missing packets by:
creating a token packet; and
passing the token packet from the proxy device to the next available node in the mesh network, each node receiving the token packet checking whether there are any missing packets and responding to the proxy device with a request for a missing packet, the proxy device resending the missing packet to the node in response to the request for the missing packet.

4. The method of claim 3, wherein the token packet is passed by the proxy device to each next available node in the mesh network.

5. The method of claim 3, wherein the token packet is passed from one node to another node in the mesh network, the node having the token packet sequentially asks for missing packets to nearby nodes.

6. The method of claim 2, wherein communication between nodes, including between the proxy device and the next available node during the cascade transfer, is unicast.

7. The method of claim 2, further comprising, before performing the cascade transfer of the bulk data, passing an over-the-air (OTA) command to the next available node to direct the next available node to enter OTA mode and pass the OTA command to its next available node.

8. The method of claim 1, wherein performing the transfer of the bulk data packet-by-packet to at least one other node in the mesh network comprises the proxy device publishing the bulk data packet-by-packet to a group of subscriber nodes in the mesh network.

9. The method of claim 8, wherein performing the unicast communication to identify missing packets comprises:
after performing the transfer of the bulk data packet-by-packet, performing, by the proxy device, a unicast poll of each subscriber node to identify any missing packets; and
upon receiving any identified missing packets from each subscriber node, republishing, by the proxy device, the identified missing packets to the group of subscriber nodes.

10. The method of claim 1, wherein the mesh network is a Bluetooth® low energy network.
